(19) United States
(12) Patent Application Publication
(10) Pub. No.: US 2017/0338716 A1
(43) Pub. Date: Nov. 23, 2017

(54) HIGH-SPEED PERMANENT MAGNETIC MOTOR ASSEMBLY

(71) Applicant: Hangzhou Stellar Mechanical & Electrical Technology, Inc., Zhejiang (CN)

(72) Inventors: Fahua Gu, San Diego, CA (US); Peng Yuan, Zhejiang (CN); Jiejie Song, Zhejiang (CN); Weixing Ji, Zhejiang (CN)

(21) Appl. No.: 15/267,879

(22) Filed: Sep. 16, 2016

(30) Foreign Application Priority Data
May 23, 2016 (CN) 201610349341.9

(51) Int. Cl. H02K 7/09; F16C 32/06; F16C 37/00

(52) U.S. Cl. CPC H02K 7/09; F16C 37/002; F16C 32/0625; F16C 32/0696; F16C 2380/26

(57) ABSTRACT

A high-speed permanent magnetic motor assembly generates a magnetic field to produce mechanical output power. The assembly comprises a motor, a motor housing, and a radial bearing block. A motor housing supports a rotor and the radial bearing block with a left radial aerostatic bearing, a right aerostatic bearing, and an axial thrust aerostatic bearing. The bearings are porous aerostatic bearings that use a low-viscous vapor-liquid two-phase fluid as a lubricant, which penetrates through a porous bushing. The liquid vaporizes from pressure reduction, and part of the liquid arrives at a clearance between each of the bearings and the rotor. The liquid of the two-phase fluid is vaporized during discharge along an axial direction from the bearing. This increases the vapor in the clearance, improve a bearing capacity, retain position accuracy of an aerostatic bearing, and cool the aerostatic bearings and the rotor.

### CROSS REFERENCE OF RELATED APPLICATIONS

This application claims the benefits of Chinese application no. 201610349341.9, filed May 23, 2016 and is titled the same.

### FIELD OF THE INVENTION

The present invention relates generally to a high-speed permanent magnetic motor assembly. More so, the present invention relates to a magnetic motor assembly that produces mechanical output power, has a self-cooling function as well as high rotation accuracy; whereby the assembly comprises a motor, a motor housing, and a radial bearing block; whereby the rotor is supported on the motor housing and the radial bearing block with a left radial aerostatic bearing, a right aerostatic bearing, and an axial thrust aerostatic bearing; whereby the left radial aerostatic bearing, the right aerostatic bearing, and the axial thrust aerostatic bearing are porous aerostatic bearings using a low-viscous vapor-liquid two-phase fluid as a lubricant.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that conventional electric motors employ magnetic forces to produce linear rotational motion. Conventional electric motors may employ permanent magnets in either the armature or stator components, but in the normal art of a conventional motor the use of permanent magnets in either the armature or stator requires a switching means to control the energization of the electromagnets to produce the motive power that acts on the fields of the permanent magnets.

Typically, a permanent magnet motor is constructed from permanent magnetics in the rotor. This adaptation extends this concept by adding additional layers of magnetics to the rotor and coils of wire combined with high permeability materials in the form of a stator to create a motor-generator. To induce the magnetic flux into the coils of wire each magnetic system in the rotor is modified such that multiple pole pairs face the coils of wire mounted in the stator. The unpaired electron spins occurring within permanent magnets are utilized to produce a motive power source solely through the superconducting characteristics of a permanent magnet and the magnetic flux created by the magnets are controlled and concentrated to orient the magnetic forces generated in such a manner to do useful continuous work, such as the displacement of a rotor with respect to a stator.

Generally, high-speed motors provide a new direct drive mode, avoiding using gearboxes to increase the rotation speed, and reducing transmission losses, and therefore are widely used in small and micro electromechanical devices. High-speed permanent magnet motors use permanent magnets to significantly reduce losses of rotors, so as to further improve efficiency of the motors.

With an increase in rotation speed (not less than 10000 RPM) and an increase in power (not less than 30 KW) of a motor, due to a restriction from strength of a material of a rotor of the motor, a high-speed permanent magnet motor needs to be compact. That is, power density of the motor is significantly improved, and an amount of heat generated per unit volume increases. A traditional manner of adding a water jacket outside a motor housing can hardly cool a stator of the motor effectively, and is of no use in cooling the rotor. An air cooling manner requires an increase in clearance between a stator and a rotor and allows an increase in ventilation volume, which not only reduces efficiency of a motor, but also increases power consumption of ventilation.

Often, high rotation speeds make a challenge for bearings: a common oil journal bearing is subjected to a sharp increase in losses with an increase in rotation speed; a ball bearing is limited by a rotation speed; although there is no friction loss, a magnetic bearing is subjected to substantial axis fluctuation during start-up or shutdown, and therefore can hardly be applied to small rotating machines.

Externally pressurized bearings, also called static bearings, are widely used for high speed and high precision applications. Pressurized fluid is fed through a restrictor (orifice, porous media or other flow throttling devices) into the gap between the bearing and load (for example, rotary shaft) to create a high-pressurized fluid film to support the load. The advantage of static bearings is that the bearing and load are constantly separated by the film, and the devices equipped with static bearings run smoothly during startup, shutdown and routine operations. The disadvantage is the need of external supply of pressurized fluids.

There are two types of static bearings available: hydrostatic bearings and aerostatic bearings; the hydrostatic use liquids and aerostatic use gases. Due to the viscosity and density difference of the lubricating media, the hydrostatic bearings and aerostatic bearings are designed and constructed differently. The liquid with higher density and higher viscosity, such as oil, leads to thicker films, that is, larger bearing gap. In contrast, the gap of the aerostatic bearing is very small, often less than 1/10 of the hydrostatic bearing clearance. Obviously, if the hydrostatic bearings are fed by gases or aerostatic bearings by liquid, with published techniques, none of them will work properly or will have the designed loading capacity.

In the disclosed patent technologies, it is common to use a radial hydrostatic bearing to improve a radial bearing capacity, and use an air thrust bearing to meet axial position accuracy. This structure needs to design a complex seal mechanism, so as to prevent a liquid lubricating oil or a vaporized lubricating oil from entering the air bearing to block an air passage.

Therefore, it is necessary to provide a high-efficiency permanent magnet motor with a high power and a high rotation speed, which has a self-cooling function as well as high rotation accuracy.

Other proposals have involved magnetic motor and generator systems. The problem with these magnetic motors is that the bearings are not stable and overheating occurs. Even though the above cited magnetic motors meets some of the needs of the market, a magnetic motor assembly that produces mechanical output power and has a rotor that is supported on the motor housing and the radial bearing block with a left radial aerostatic bearing, a right aerostatic bearing, and an axial thrust aerostatic bearing; whereby the left radial aerostatic bearing, the right aerostatic bearing, and the axial thrust aerostatic bearing are porous aerostatic bearings using a low-viscous vapor-liquid two-phase fluid as a lubricant, is still desired.

### SUMMARY

Illustrative embodiments of the disclosure are generally directed to a high-speed permanent magnetic motor assembly that produces mechanical output, while exhibiting a self-cooling function as well as high rotation accuracy. The high-speed permanent magnetic motor assembly is constructed from permanent magnetics positioned in a rotor. The assembly also adds additional layers of magnetics to the rotor and coils of wire combined with high permeability materials in the form of a stator to create a motor-generator. To induce the magnetic flux into the coils of wire each magnetic system in the rotor is modified such that multiple pole pairs face the coils of wire mounted in the stator.

Consequently, the unpaired electron spins occurring within the permanent magnets are utilized to produce a motive power source through the superconducting characteristics of the permanent magnet. The magnetic flux created by the magnets are controlled and concentrated to orient the magnetic forces generated in such a manner to do useful continuous work, such as the displacement of a rotor with respect to a stator.

The high-speed permanent magnetic motor assembly generates a magnetic field to produce mechanical output power. The assembly comprises a motor, a motor housing, and a radial bearing block. A rotor is supported on the motor housing and the radial bearing block with a left radial aerostatic bearing, a right aerostatic bearing, and an axial thrust aerostatic bearing. The left radial aerostatic bearing, the right aerostatic bearing, and the axial thrust aerostatic bearing are porous aerostatic bearings using a low-viscous vapor-liquid two-phase fluid as a lubricant.

A liquid phase of the low-viscous two-phase fluid has a low viscosity coefficient, to penetrate through a porous bushing, during which a part of the liquid is vaporized due to pressure reduction from the resistance of the porous media, and a part of the liquid arrives at a clearance between each of the bearings and the rotor. The liquid of the low-viscous two-phase fluid is vaporized during discharge, along an axial direction from the bearing to increase the vapor in the clearance, improve a bearing capacity of the assembly, retain position accuracy of an aerostatic bearing. The liquid in the low-viscous two-phase fluid simultaneously cools the aerostatic bearings and the rotor of the motor during the vaporization process.

The high-speed permanent magnetic motor assembly provides the advantage of using multiple aerostatic bearings. The aerostatic bearings incorporate a vapor-liquid two-phase refrigerant. The aerostatic bearings form gas films through use of a gas phase fluid and a liquid phase fluid. This improves the bearing capacities of the aerostatic bearings. Furthermore, when the liquid phase fluid is vaporized, a large amount of heat can be absorbed, which cools a rotor of the motor and the bearings.

In one embodiment, the assembly comprises a motor. The assembly further comprises a motor housing having a housing portion and an end cover portion. The housing portion is defined by a generally cylindrical shape. The end cover portion is disposed at a left end of the housing portion. The end cover portion is configured to seal an opening at the left end of the housing portion. A rotor is rotatably disposed in the motor housing.

The assembly further include a radial bearing block that is configured to fasten to a right end of the housing portion. The radial bearing block is further configured to seal an opening at the right end of the housing portion. The radial bearing block comprises a right through hole that is disposed along a left-to-right direction in the radial bearing block. The right through hole comprises an inner wall surface defined by a right vapor-liquid groove. The right through hole comprises a right porous bushing of a right radial aerostatic bearing. A right end of the rotor is disposed in the right porous bushing.

The end cover portion comprises a left through hole disposed in a left-to-right direction. The left through hole comprises an inner wall surface having a left vapor-liquid groove. The left through hole comprises a left porous bushing of a left radial aerostatic bearing. A left end of the rotor is disposed in the left porous bushing. The left end of the rotor is supported on the end cover portion by using an axial thrust aerostatic bearing;

In some embodiments, the left radial aerostatic bearing, the right radial aerostatic bearing, and the axial thrust aerostatic bearing are all porous aerostatic bearings that use a low-viscous vapor-liquid two-phase fluid as a lubricating medium.

In another embodiment, the assembly comprises a stator. The stator is located between the rotor and the housing portion. The stator is formed by a silicon steel sheet and a coil, and the coil is wound on the silicon steel sheet. An annular groove is formed on an inner wall surface of the housing portion. An axis of the annular groove coincides with an axis of the housing portion. A width of a left-to-right direction of the silicon steel sheet is greater than a width of a left-to-right direction of the annular groove. The silicon steel sheet is installed on the inner wall of the housing portion, and covers the annular groove, so as to form a cavity between the silicon steel sheet and the inner wall surface of the motor housing.

In another embodiment, the housing portion comprises an inlet channel for a low-viscous two-phase fluid to enter. The housing portion also comprises an outlet channel for a low-viscous two-phase fluid to be discharged. The inlet channel is in communication with the annular groove. The outlet channel is connected to a condenser. The housing portion is further provided with a left cooling channel and a right cooling channel.

One end of the left cooling channel is in communication with the inlet channel, and the other end is in communication with accommodation space at a left side of the stator. One end of the right cooling channel is in communication with the inlet channel, and the other end is in communication with accommodation space at a right side of the stator.

In some embodiments, the radial bearing block is provided with a right fluid groove that is in communication with the right vapor-liquid groove. The end cover portion is provided with a left fluid groove that is in communication with the left vapor-liquid groove.

The axial thrust aerostatic bearing is located at a left side of the left radial aerostatic bearing. The axial thrust aerostatic bearing includes two thrust bearings and an adjustment ring; porous rings of the two thrust bearings are oppositely disposed, and the adjustment ring is located between the porous rings of the two thrust bearings. A cavity between the oppositely disposed axial thrust aerostatic bearings is provided with a thrust disc fastened to the rotor.

Each of the thrust bearings includes a shallow cylindrical housing and a porous ring. Each of the shallow cylindrical housings is provided with an accommodation groove, and the corresponding porous ring is disposed in the accommodation groove. Each of the porous rings is provided with a fluid channel. Each of the shallow cylindrical housings is provided with a fluid groove. The fluid groove is in communication with the corresponding fluid channel. Each of the fluid channels extends inwards from a circumferential surface of the corresponding porous ring along a radial direction of the porous ring. The high-speed permanent magnet motor further includes a right seal, where the right seal is fastened to the radial bearing block, and the right seal is a seal member or a seal ring.

The high-speed permanent magnet motor further includes a left seal, where the left seal is fastened to the end cover portion. The left seal is a seal ring. A left end of the rotor penetrates through the seal ring. The seal ring is in sealing contact with the rotor of the motor.

In some embodiments, the assembly further includes a refrigerant cycle system, where the refrigerant cycle system includes a heating tank, a condenser, and a pump. The heating tank is configured to heat a lubricating medium, so as to form a high-temperature high-pressure saturated gas. A gas outlet of the heating tank is separately in communication with the left vapor-liquid groove of the left radial aerostatic bearing, the right vapor-liquid groove of the right radial aerostatic bearing, and the fluid grooves of the axial thrust aerostatic bearing. The high-temperature high-pressure saturated gas is partially liquefied in the left radial aerostatic bearing, the right radial aerostatic bearing, and the fluid grooves of the axial thrust aerostatic bearing.

The outlet channel is in communication with the condenser. A suction port of the pump is in communication with the condenser, and a discharge port is in communication with a liquid inlet of the heating tank.

The present invention has the following beneficial effects: in the high-speed permanent magnet motor of the present invention, a rotor is supported by using a left radial aerostatic bearing, a right radial aerostatic bearing, and an axial thrust aerostatic bearing. A low-viscous two-phase fluid is used as a lubricating medium. A pressure of a fluid is reduced when the fluid penetrates through each porous bushing.

A gas phase of the low-viscous two-phase fluid penetrates through the porous bushing, so as to form a clearance between a corresponding bearing and the rotor, which is the same as that in the disclosed porous aerostatic bearing, thereby separating the bearing from the rotor. A liquid phase of the low-viscous two-phase fluid has a feature of a low viscosity coefficient, and therefore can penetrate through the porous bushing, during which a part of the liquid is vaporized due to pressure reduction. A portion of the liquid arrives at the clearance between the bearing and the rotor and is continued to be vaporized during a process of being discharged, along an axial direction, from the bearing.

This increases the gas in the clearance and restricts penetration of the gas through the porous bushing. This results in reducing a pressure loss, improving a bearing capacity of the aerostatic bearing, and retaining position accuracy of the aerostatic bearing. Further, the liquid part of the low-viscous two-phase fluid simultaneously cools the aerostatic bearings and the rotor of the motor during the gasification process.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 is a schematic structural diagram of a high-speed permanent magnet motor according to the present invention;

FIG. 2 is a schematic structural diagram of a radial bearing block according to the present invention;

FIG. 3 is a schematic structural diagram of a refrigerant cycle system for the high-speed permanent magnet motor according to the present invention;

FIG. 4 is a schematic structural diagram of an axial thrust aerostatic bearing according to the present invention; and

FIG. 5 is a schematic structural diagram of a thrust bearing according to the present invention.

Like reference numerals refer to like parts throughout the various views of the drawings.

### DETAILED DESCRIPTION OF THE INVENTION

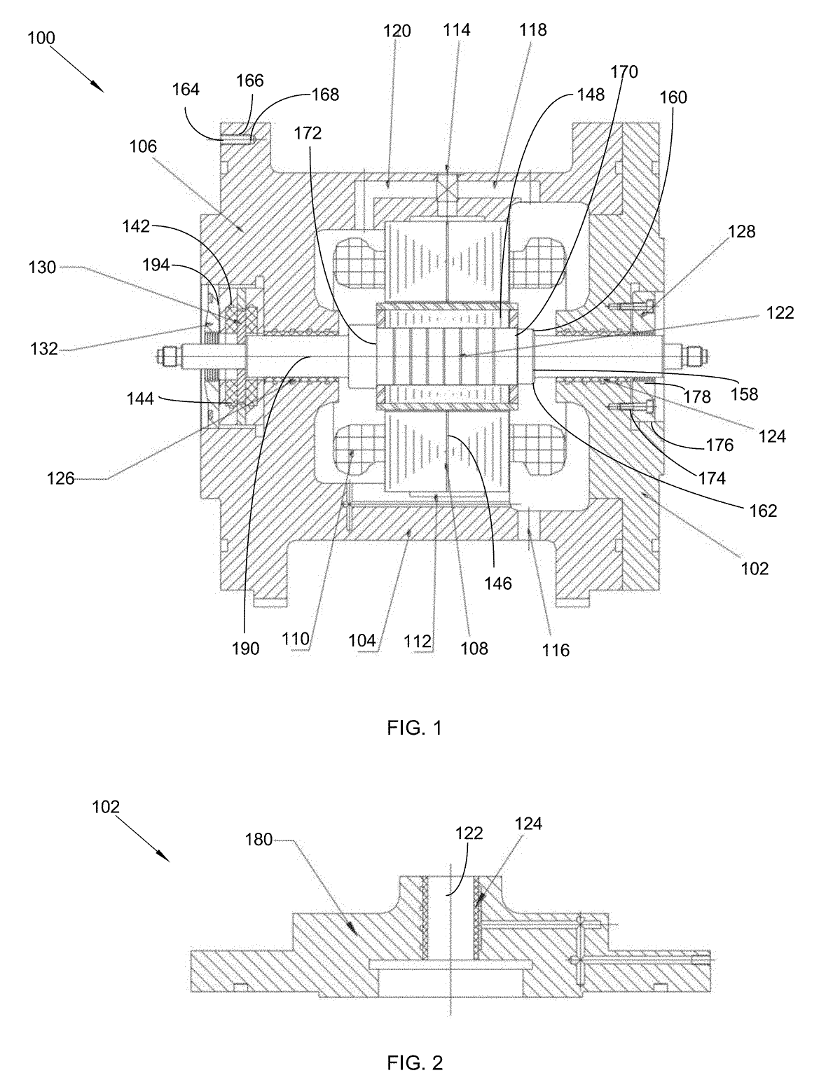

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A high speed permanent magnet motor assembly 100 is referenced in FIGS. 1-5. The high-speed permanent magnet motor assembly 100, hereafter “assembly 100” produces mechanical output for operation of a motor through inducement of a magnetic field. The assembly 100 comprises a motor 148, a motor housing 180, and a radial bearing block 102. A rotor 122 is supported on the motor housing 180 and the radial bearing block 102 with a left radial aerostatic bearing 142, a right aerostatic bearing 144, and an axial thrust aerostatic bearing 130. The left radial aerostatic bearing 142, the right aerostatic bearing 144, and the axial static pressure 130 bearing are porous aerostatic bearings using a low-viscous vapor-liquid two-phase fluid as a lubricant.

In some embodiments, a liquid phase of the low-viscous two-phase fluid has a low viscosity coefficient, to penetrate through a porous bushing, during which a part of the liquid is vaporized due to pressure reduction, and a part of the liquid arrives at a clearance between each of the bearings and the rotor. The liquid of the low-viscous two-phase fluid is vaporized during discharge, along an axial direction from the bearing to increase the gas in the clearance, improve a bearing capacity of the assembly 100, retain position accuracy of an aerostatic bearing. The liquid in the low-viscous two-phase fluid simultaneously cools the aerostatic bearings and the rotor of the motor during the gasification process.

As referenced in FIG. 1, the assembly 100 comprises a motor housing 180 and a radial bearing block 102. The motor housing includes a housing portion 104 and an end cover portion 106. The housing portion assumes a cylindrical shape. In the housing portion, accommodation space penetrating through the housing portion is formed along an axial direction of the housing portion. The end cover portion 106 is disposed at a left end 182 of the housing portion 104, and seals an opening 184 at the left end 182 of the housing portion 104. In this embodiment, the housing portion 104 and the end cover portion 106 may be integrally formed, by using a die casting method, for example, to form the motor housing.

Turning now to FIG. 2, the radial bearing block 102 is fastened to a right end 186 of the motor housing 180, and seals an opening 188 at the right end of the housing portion 104. In this embodiment, the motor housing 180 and the radial bearing block 102 work to seal the accommodation space, so as to prevent, when a low-viscous two-phase fluid entering the accommodation space is vaporized and generates a gas phase of the low-viscous two-phase fluid, the gas phase of the low-viscous two-phase fluid from being leaked to the outside of the accommodation space.

A stator 158 is installed on an inner wall of the motor housing. In this embodiment, the stator 158 is formed by a silicon steel sheet 108 and a coil 110, and the coil is wound on the silicon steel sheet. The coil at an outer side of the silicon steel sheet forms end portions of the stator. A part of the silicon steel sheet and the motor housing are in a hot pressing fit, that is, the silicon steel sheet can transfer heat generated by the silicon steel sheet to the motor housing.

In this embodiment, an annular groove 112 is formed on an inner wall surface of the housing portion. A groove axis 146 of the annular groove 112 coincides with a housing axis 190 of the housing portion 104. A width of a left-to-right direction of the silicon steel sheet is greater than a width of a left-to-right direction of the annular groove 112. When the silicon steel sheet is installed on the inner wall of the housing portion, the silicon steel sheet covers the annular groove, and a cavity is formed between the silicon steel sheet and the inner wall surface of the motor housing. The cavity is the annular groove. At this time, the cavity can be used to store a low-viscous two-phase fluid.

In order to supply the low-viscous two-phase fluid to the annular groove, the motor housing is further provided with an inlet channel 114 for a low-viscous two-phase fluid to enter and an outlet channel 116 for a low-viscous two-phase fluid to be discharged. The inlet channel is in communication with the annular groove 112, and the outlet channel is connected to the condenser, so as to enable a pressure in the motor housing to be equal to a saturation pressure of the condenser.

In this embodiment, in order to cool the end portions of the stator, the housing portion is further provided with a left cooling channel 118 and a right cooling channel 120. One end of the left cooling channel is in communication with the inlet channel, and the other end is in communication with accommodation space at a left side 160 of the stator. One end of the right cooling channel is in communication with the inlet channel, and the other end is in communication with accommodation space at a right side of the stator. When the low-viscous two-phase fluid is supplied by using the inlet channel, the low-viscous two-phase fluid can enter the left side 160 and a right side 162 of the stator 158, so as to effectively cool the end portions at the left side 160 and the right side 162 of the stator 158.

In this embodiment, a rotor 122 is further disposed in the motor housing, and the rotor is co-axially disposed in the stator. In this embodiment, two ends of the rotor are supported on the motor housing separately by using a left radial aerostatic bearing and a right radial aerostatic bearing, and a left end of the rotor is supported on the motor housing by using an axial thrust aerostatic bearing, so that the rotor can rotate at a high speed in the stator of the motor with the support of the radial aerostatic bearings and can bear axial thrust of a left direction and a right direction with the support of the axial thrust aerostatic bearing, thereby enabling the rotor to have relatively high axial position accuracy.

The right radial aerostatic bearing 144 includes a right porous bushing 124. In this embodiment, a right through hole 174 is provided along a left-to-right direction in the radial bearing block 102. An inner wall surface 176 of the right through hole of the radial bearing block 102 is provided with a right vapor-liquid groove 178. The right porous bushing 124 is disposed in the right through hole 174. A right end 170 of the rotor 122 is disposed in the right porous bushing 124, so as to enable a high-temperature high-pressure vapor-liquid two-phase refrigerant to enter, by permeating the porous material from the right vapor-liquid groove, which is a small clearance between the right radial aerostatic bearing 144 and the rotor 122.

In the clearance, the gas and liquid refrigerants support the rotor together. Because the liquid is incompressible, the right radial aerostatic bearing, as compared with an air bearing, has a higher bearing capacity and higher stiffness. An amount of refrigerant entering the clearance depends on a pressure difference of two sides of the porous material. A pressure reduction process is also a cooling process. A part of the liquid refrigerant is vaporized, due to the pressure reduction, to generate a low-temperature gas refrigerant and liquid refrigerant, so as to cool the right radial aerostatic bearing and the rotor.

The left radial aerostatic bearing 142 includes a left porous bushing 126. In this embodiment, a left through hole 164 is provided along a left-to-right direction in the end cover portion 106. An inner wall surface 166 of the left through hole 164 of the end cover portion 106 is provided with a left vapor-liquid groove 168. The left porous bushing is disposed in the left through hole. A left end of the rotor is disposed in the left porous bushing, so as to enable a high-temperature high-pressure vapor-liquid two-phase refrigerant to enter, by permeating the porous material from the left vapor-liquid groove, a small clearance between the left radial aerostatic bearing and the rotor.

In the clearance, the gas and liquid refrigerants support the rotor together. Because the liquid is incompressible, the left radial aerostatic bearing, as compared with an air bearing, has a higher bearing capacity and higher stiffness. An amount of refrigerant entering the clearance depends on a pressure difference of two sides of the porous material. A pressure reduction process is also a cooling process. A part of the liquid refrigerant is vaporized, due to the pressure reduction, to generate a low-temperature gas refrigerant and liquid refrigerant, so as to cool the left radial aerostatic bearing and the rotor.

In this embodiment, the radial bearing block is provided with a right fluid groove, and the right fluid groove is in communication with the right vapor-liquid groove. Meanwhile, the end cover portion is provided with a left fluid groove, and the left fluid groove is in communication with the left vapor-liquid groove.

In this embodiment, in order to seal the right radial aerostatic bearing 144, the high-speed permanent magnet motor further includes a right seal 128, and the right seal is fastened to the radial bearing block 102. In this embodiment, the right seal may be a seal member or a seal ring. When the right seal is a seal cover, the right seal covers a right end 170 of the rotor 122 and the right radial aerostatic bearing 144, and at this time, the motor 148 is a single-output motor, that is, a left end 172 of the rotor 122 can output power. When the right seal is a seal ring, the right end 170 of the rotor 122 penetrates through the seal ring. At this time, the right end 170 of the rotor 122 can also output power, and the seal ring is in sealing contact with the rotor of the motor.

Looking now at FIG. 4, the axial thrust aerostatic bearing 130 includes two oppositely disposed thrust bearings 192a, 192b. An adjustment ring 134 is disposed between the two thrust bearings 192a, 192b. Each of the thrust bearings 192a, 192b includes a shallow cylindrical housing 136 and a porous ring (FIG. 5). Each of the shallow cylindrical housings is provided with an accommodation groove, and the corresponding porous ring is disposed in the accommodation groove. Each of the porous rings 138 is provided with a fluid channel. Each of the shallow cylindrical housings is provided with a fluid groove. The fluid groove is in communication with the corresponding fluid channel, so as to enable a low-viscous two-phase fluid, formed after cooling a high-temperature high-pressure saturated gas entering the fluid groove, to enter the fluid groove, to penetrate through the porous ring, and further to enter a clearance between the porous ring and the adjustment ring, thereby limiting an axial position of the rotor by using the adjustment ring. In this embodiment, each of the fluid channel extends inwards from a circumferential surface of the corresponding porous ring along a radial direction of the porous ring.

The porous rings of the two thrust bearings are oppositely disposed, that is, the adjustment ring is located between the porous rings of the two thrust bearings. A cavity between the oppositely disposed axial thrust aerostatic bearings is provided with a thrust disc 140. The rotor includes a shaft shoulder. The rotor penetrates through the thrust disc. The thrust disc is fitted with the axial direction and is fastened to the rotor, so as to limit the axial position of the rotor by controlling a position of the adjustment ring.

Looking back at FIG. 1, the axial thrust aerostatic bearing 130 is located at a left region 194 of the left radial aerostatic bearing 142. In this embodiment, in order to seal the left radial aerostatic bearing 142, the high-speed permanent magnet motor further includes a left seal 132, and the left seal is fastened to the end cover portion 106. The left seal 132 is a seal ring. The left end of the rotor penetrates through the seal ring, and at this time, the left end of the rotor of the motor can output power. The sear ring is in sealing contact with the rotor of the motor.

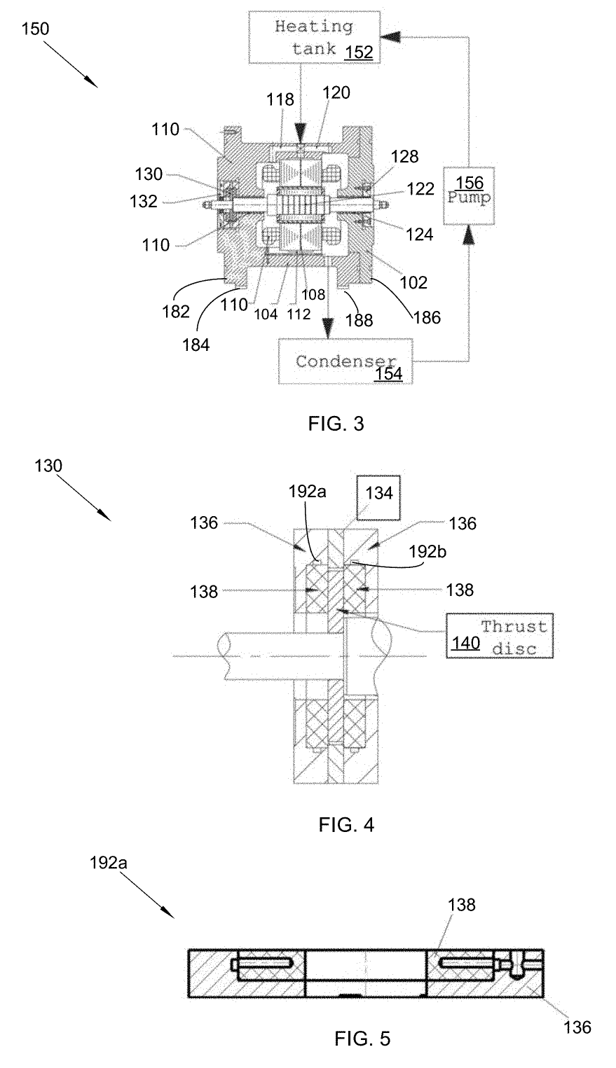

The assembly 100 further includes a refrigerant cycle system 150, as referenced in FIG. 3. The refrigerant cycle system 150 includes a heating tank 152, a condenser 154, and a pump 156. The heating tank 152 is configured to heat the low-viscous two-phase fluid therein, so as to raise a saturation temperature of the fluid. Features of a two-phase fluid show that: a high saturation temperature corresponds to a high saturation pressure. A liquid baffle is installed in the heating tank, so as to adjust an amount of liquid contained in a gas supplied to the aerostatic bearings (including the left radial aerostatic bearing, the right radial aerostatic bearing, and the axial thrust aerostatic bearing).

For the radial aerostatic bearings, the saturated gas from the heating tank enters the vapor-liquid grooves of the radial aerostatic bearings, that is, a gas outlet of the heating tank is in communication with the vapor-liquid grooves (or fluid grooves) of the radial aerostatic bearings. Temperatures of the radial aerostatic bearings are less than a temperature of the heating tank, and therefore, a gas refrigerant (an example of a low-viscous two-phase fluid) is cooled to form a vapor-liquid two-phase fluid in the radial aerostatic bearings. After passing through the porous bushing of each of the radial aerostatic bearings, the liquid-gas two-phase fluid enters a small clearance between the radial aerostatic bearing and the rotor. At two ends of each of the radial aerostatic bearings, the pressure of the gas in the clearance is decreased to a saturation pressure in the condenser. A pressure of an axial central position of the clearance is relatively high. The pressure is gradually decreased with the vapor-liquid two-phase fluid flowing to two ends of the clearance. The liquid is vaporized, so as to cool the radial aerostatic bearing and the rotor.

For the axial thrust aerostatic bearing 130, the saturated gas from the heating tank 152 enters the fluid grooves of the axial thrust aerostatic bearing, that is, the gas outlet of the heating tank is in communication with the fluid grooves of the axial thrust aerostatic bearing. A temperature of the axial thrust aerostatic bearing is less than a temperature of the heating tank, and therefore, a gas refrigerant is cooled to form a vapor-liquid two-phase fluid in the axial thrust aerostatic bearing. After passing through the porous rings of the axial thrust aerostatic bearing, the liquid-gas two-phase fluid enters a small clearance between the aerostatic bearing and the thrush disc. At an edge of the axial thrust aerostatic bearing, the pressure of the gas in the clearance is decreased to a saturation pressure in the condenser. A pressure of a radial central position of the clearance is relatively high. The pressure is gradually decreased with the vapor-liquid two-phase fluid flowing to two ends of the clearance. The liquid is vaporized, so as to cool the aerostatic bearing and the adjustment ring.

The gas refrigerant and the liquid refrigerant discharged from the aerostatic bearings, and the refrigerant for cooling the stator of the motor enter the condenser by using the outlet channel, so as to liquefy the gas refrigerant in the condenser, and then are pressurized by the pump and pumped back to the heating tank, thereby completing the circulation of the refrigerants. That is, a suction port of the pump is in communication with the condenser, and a discharge port is in communication with a liquid inlet of the heating tank.

In the high-speed permanent magnet motor of the present invention, a rotor is supported by using a left radial aerostatic bearing, a right radial aerostatic bearing, and an axial thrust aerostatic bearing; a low-viscous two-phase fluid is used as a lubricating medium; a pressure of the low-viscous two-phase fluid is reduced when the low-viscous two-phase fluid penetrates through each porous bushing; and a gas phase of a low-viscous two-phase fluid penetrates through the porous bushing, so as to form a clearance between a corresponding bearing and the rotor, which is the same as that in the disclosed porous aerostatic bearing, thereby separating the bearing from the rotor.

A liquid phase of the low-viscous two-phase fluid has a feature of a low viscosity coefficient, and therefore can penetrate through the porous bushing, during which a part of the liquid is vaporized due to pressure reduction, and a part of the liquid arrives at the clearance between the bearing and the rotor. This part of liquid of the low-viscous two-phase fluid is continued to be vaporized during a process of being discharged, along an axial direction, from the bearing, so as to increase an amount of gas in the clearance and reduce an amount of fluid that penetrates through the porous bushing, thereby reducing a pressure loss, improving a bearing capacity of the aerostatic bearing, and further enabling the high-speed permanent magnet motor to work at a state of a high rotation speed and to have relatively high accuracy. Moreover, the liquid phase of the low-viscous two-phase fluid also cools the aerostatic bearings and the rotor during the gasification process.

The order of the foregoing embodiments is used for description only, and cannot be considered as a criterion for evaluating the embodiments. Finally, it should be noted that the foregoing embodiments are merely intended to describe the technical solutions of the present invention, rather than limit same. Although the present invention is described in detail with reference to the aforementioned embodiments, it should be understood by a person of ordinary skill in the art that: a person of ordinary skill in the art can make modifications to the technical solutions recorded in the aforementioned embodiments, or equivalent replacements to some technical features thereof, and the modifications or replacements would not enable the essence of the corresponding technical solution to be departed from the spirit and scope of the technical solutions of the embodiments of the present invention.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A magnetic motor assembly, the assembly comprising:
a motor;
a motor housing, the motor housing comprises a housing portion and an end cover portion, the housing portion defined by a generally cylindrical shape, the end cover portion disposed at a left end of the housing portion, the end cover portion configured to seal an opening at the left end of the housing portion;
a rotor, the rotor rotatably disposed in the motor housing;
a radial bearing block, the radial bearing block configured to fasten to a right end of the housing portion, the radial bearing block further configured to seal an opening at the right end of the housing portion;
a right radial aerostatic bearing;
a left radial aerostatic bearing;
an axial thrust aerostatic bearing;
whereby a right through hole is provided along a left-to-right direction in the radial bearing block;
whereby an inner wall surface of the right through hole of the radial bearing block is provided with a right vapor-liquid groove;
whereby the right through hole comprises a right porous bushing of the right radial aerostatic bearing;
whereby a right end of the rotor is disposed in the right porous bushing;
whereby a left through hole is provided along a left-to-right direction in the end cover portion;
whereby an inner wall surface of the left through hole of the end cover portion is provided with a left vapor-liquid groove;
whereby the left through hole is provided with a left porous bushing of the left radial aerostatic bearing;
whereby a left end of the rotor is disposed in the left porous bushing;
the left end of the rotor is further supported on the end cover portion with the axial thrust aerostatic bearing; and
the left radial aerostatic bearing, the right radial aerostatic bearing, and the axial thrust aerostatic bearing comprise aerostatic bearings; and
whereby the left radial aerostatic bearing, the right radial aerostatic bearing, and the axial thrust aerostatic bearing are configured to be lubricated with a low-viscous vapor-liquid two-phase fluid.

2. The assembly of claim 1, further comprising a stator disposed between the rotor and the housing portion.

3. The assembly of claim 2, wherein the stator comprises a silicon steel sheet and a coil, the coil configured to wind about the silicon steel sheet.

4. The assembly of claim 3, wherein the housing portion comprises an inner wall surface having an annular groove; whereby the annular groove comprises a groove axis that is configured to correlate with a housing axis of the housing portion.

5. The assembly of claim 4, wherein a width of a left-to-right direction of the silicon steel sheet is greater than a width of a left-to-right direction of the annular groove.

6. The assembly of claim 5, wherein the silicon steel sheet is configured to join with the inner wall of the housing portion, the silicon steel sheet further configured to cover the annular groove, so as to form a cavity between the silicon steel sheet and the inner wall surface of the motor housing.

7. The assembly of claim 6, wherein the housing portion comprises an inlet channel configured to enable passage of a low-viscous two-phase fluid, the housing portion further comprising an outlet channel configured to enable discharge of the low-viscous two-phase fluid; whereby the inlet channel is in communication with the annular groove; whereby the outlet channel is connected to a condenser.

8. The assembly of claim 7, wherein the housing portion comprises a left cooling channel and a right cooling channel; whereby one end of the left cooling channel is in communication with the inlet channel, and the other end of the left cooling channel is in communication with accommodation space at a left side of the stator; whereby one end of the right cooling channel is in communication with the inlet channel, and the other end of the right cooling channel is in communication with accommodation space at a right side of the stator.

9. The assembly of claim 8, wherein the radial bearing block comprises a right fluid groove configured to be in communication with the right vapor-liquid groove.

10. The assembly of claim 9, wherein the end cover portion comprises a left fluid groove configured to be in communication with the left vapor-liquid groove.

11. The assembly of claim 10, wherein the axial thrust aerostatic bearing is disposed at a left region of the left radial aerostatic bearing.

12. The assembly of claim 11, wherein the axial thrust aerostatic bearing comprises two thrust bearings and an adjustment ring, the two thrust bearing comprising a plurality of oppositely porous rings disposed oppositely from each other, the adjustment ring disposed between the plurality of porous rings.

13. The assembly of claim 12, wherein a cavity forms between the oppositely disposed axial thrust aerostatic bearings.

14. The assembly of claim 13, further including a thrust disc configured to fasten to the rotor.

15. The assembly of claim 14, wherein each of the thrust bearings comprises a shallow cylindrical housing and a porous ring; whereby each of the shallow cylindrical housings comprises an accommodation groove; whereby the corresponding porous ring is disposed in the accommodation groove; whereby each of the porous rings comprises a fluid channel; whereby each of the shallow cylindrical housings comprises a fluid groove; whereby the fluid groove is configured to be in communication with the corresponding fluid channel.

16. The assembly of claim 15, wherein each of the fluid channels is configured to extend inwardly from a circumferential surface of the corresponding porous ring along a radial direction of the porous ring.

17. The assembly of claim 16, further comprising a right seal configured to fasten to the radial bearing block; whereby the right seal is a seal member or a seal ring.

18. The assembly of claim 17, further comprising a left seal configured to fasten to the end cover portion; whereby the left seal is a seal ring; whereby a left end of the rotor penetrates through the seal ring; whereby the seal ring is in sealing contact with the rotor.

19. The assembly of claim 18, further comprising: a refrigerant cycle system, the refrigerant cycle system comprising a heating tank, a condenser, and a pump; whereby the heating tank is configured to heat a high-temperature high-pressure saturated gas; whereby a gas outlet of the heating tank is in communication with the left vapor-liquid groove of the left radial aerostatic bearing, the right vapor-liquid groove of the right radial aerostatic bearing, and the fluid grooves of the axial thrust aerostatic bearing; whereby the high-temperature high-pressure saturated gas is partially liquefied in the left radial aerostatic bearing, the right radial aerostatic bearing, and the fluid grooves of the axial thrust aerostatic bearing; whereby the outlet channel is in communication with the condenser; whereby a suction port of the pump is in communication with the condenser; whereby a discharge port is in communication with a liquid inlet of the heating tank.

20. A magnetic motor assembly, the assembly comprising:
a motor;
a motor housing, the motor housing comprises a housing portion and an end cover portion, the housing portion defined by a generally cylindrical shape, the end cover portion disposed at a left end of the housing portion, the end cover portion configured to seal an opening at the left end of the housing portion;
a rotor, the rotor rotatably disposed in the motor housing;
a radial bearing block, the radial bearing block configured to fasten to a right end of the housing portion, the radial bearing block further configured to seal an opening at the right end of the housing portion;
a stator disposed between the rotor and the housing portion;
whereby the stator comprises a silicon steel sheet and a coil, the coil configured to wind about the silicon steel sheet;
a right radial aerostatic bearing;
a left radial aerostatic bearing;
an axial thrust aerostatic bearing;
whereby a right through hole is provided along a left-to-right direction in the radial bearing block;
whereby an inner wall surface of the right through hole of the radial bearing block is provided with a right vapor-liquid groove;
whereby the right through hole comprises a right porous bushing of the right radial aerostatic bearing;
whereby a right end of the rotor is disposed in the right porous bushing;
whereby a left through hole is provided along a left-to-right direction in the end cover portion;
whereby an inner wall surface of the left through hole of the end cover portion is provided with a left vapor-liquid groove;
whereby the left through hole is provided with a left porous bushing of the left radial aerostatic bearing;
whereby a left end of the rotor is disposed in the left porous bushing;
the left end of the rotor is further supported on the end cover portion with the axial thrust aerostatic bearing; and
the left radial aerostatic bearing, the right radial aerostatic bearing, and the axial thrust aerostatic bearing comprise aerostatic bearings;
whereby the left radial aerostatic bearing, the right radial aerostatic bearing, and the axial thrust aerostatic bearing are configured to be lubricated with a low-viscous vapor-liquid two-phase fluid; and
a refrigerant cycle system, the refrigerant cycle system comprising a heating tank, a condenser, and a pump; and
whereby the heating tank is configured to heat a high-temperature high-pressure saturated gas.
